(19) United States
(12) Patent Application Publication
(10) Pub. No.: US 2017/0313285 A1
(43) Pub. Date: Nov. 2, 2017

(54) WIPER BLADE ASSEMBLY

(71) Applicant: CAP CORPORATION, Sangju-si (KR)

(72) Inventors: Tae Hun KIM, Dalseo-gu (KR); Hyung Tae KIM, Namdong-gu (KR); Jae Woong KIM, Sangju-si (KR); Young Hun LIM, Sangju-si (KR)

(21) Appl. No.: 15/144,076

(22) Filed: May 2, 2016

(51) Int. Cl. B60S 1/38; B60S 1/40; B60S 1/34

(52) U.S. Cl. CPC B60S 1/3851; B60S 1/3463; B60S 1/40

(57) ABSTRACT

A wiper blade assembly including an varying width elastic member having a first elastic member region and a second elastic member region, wherein the first elastic member region includes a first body part extending in a first direction from a center part of the elastic member; a first end part provided at an end of the first body part; and a first body part center point which is the center of the length of the first body part, and a region ranging from the center part to the first body part center point is a first width maintaining part, and a region ranging from the first end part to the first body part center point is a first width varying part, the elastic member having a curvature applied thereto depending on the length thereof may enable the pressing pressure to be uniformly distributed in the lengthwise direction of the wiper blade assembly.

### BACKGROUND

### 1. Technical Field

The present inventive concept relates to a wiper blade assembly, and more particularly, to a wiper blade assembly with uniform distribution of pressing pressure.

### 2. Description of the Related Art

A vehicular windshield has a wiper blade assembly for wiping away rainwater during raining or dust and the like to provide clear vision to a driver. The wiper blade assembly operates in connection with a wiper arm connected to a driving shaft connected to a vehicle side wiper driving motor.

In this case, the wiper arm and the wiper blade assembly are coupled to each other through a wiper connector, and generally the wiper blade assembly is provided with a clamp. A connector member is coupled to the clamp, and the wiper arm is coupled to the connector member in the state where the connector member is coupled to the clamp.

The wiper blade assembly generally includes a tight contact member for removing rain, dust or the like from a window, an spring elastic member for supporting the tight contact member, and a cover member for covering the elastic spring member and extending in a lengthwise direction of the elastic member.

The wiper blade assembly can be roughly classified into a conventional type and a flat type according to the structure of a blade. In a conventional type blade, the spring elastic member consists of metal that extends the length of the contact member and helps to keep the member in contact with the windshield when pushed by a bracketed cover member, which is in turn forced by the wiper arm. In a flat type wiper blade, the spring elastic member or elastic member consists of pre-formed steel that is curved more severely than the windshield such that when pushed or forced by the wiper arm, the steel acts elastically as a spring to help keep the contact member in contact with the windshield.

Furthermore, the wiper blade assembly includes a joint cover coupled to the elastic member, and the joint cover may include a structure being connectible to an adaptor.

In this case, as described above, the wiper blade assembly is generally structured in a manner allowing the wiper arm to be coupled to the connector member of the wiper blade assembly, and the wiper blade assembly to perform wiping operation by the driving force of the wiper arm.

In this case, the wiper arm presses the wiper blade assembly with a predetermined pressing pressure, and the wiper blade assembly tightly contacts a vehicular windshield by the pressing pressure.

That is, to improve wiping characteristics of the wiper blade assembly, excellent contact characteristics between the wiper blade assembly and the vehicular windshield are required, and the pressing pressure applied to the wiper blade assembly is desired to be uniformly distributed to ensure excellent contact characteristics.

However, a general wiper blade assembly is structured in a manner allowing the pressing pressure of the wiper arm to be applied to a point where the wiper arm is coupled to the wiper blade assembly, for example, the center of the wiper blade assembly, and distributed toward ends of the wiper blade assembly, either through use of a spring elastic member or a spring elastic member in combination with a bracketed cover structure.

Thus, the pressing pressure may not be uniform. In flat type wiper blades, the pressure may not be uniform at the center and ends of the wiper blade assembly, for example, the pressing pressure applied from the wiper arm become weaker from the center toward the ends of the wiper blade assembly, causing problems of non-uniformity in the distribution of pressing pressure in a lengthwise direction of the wiper blade assembly.

### SUMMARY

An embodiment of the present inventive concept provides a wiper blade assembly in which a pressing pressure applied from a wiper arm is uniformly distributed in a lengthwise direction of the wiper blade assembly.

However, embodiments of the present inventive concept are not restricted to those set forth herein. The other embodiments of the present inventive concept which are not mentioned herein will become more apparent to one of ordinary skilled in the art to which the present inventive concept pertains by referencing the detailed description of the present inventive concept given below.

According to an aspect of the present inventive concept, there is provided a wiper blade assembly including an pre-formed steel, i.e. elastic member having a varying width. The elastic member having a first elastic member region and a second elastic member region, wherein the first elastic member region includes a first body part extending in a first direction from a center part of the elastic member; a first end part provided at an end of the first body part; and a first body part center point which is the center of the length of the first body part, and a region ranging from the center part to the first body part center point is a first width maintaining part, and a region ranging from the first end part to the first body part center point is a first width varying part.

Furthermore, the first width varying part includes a first width reduction part, and the first width reduction part starts a reduction of a width of the elastic member at a first width reduction start part and ends the reduction of the width of the elastic member at a first width reduction end part.

Furthermore, the varying width elastic member includes the first width reduction part that has a length of 80±5 mm.

Furthermore, the first width varying part of the varying width elastic member includes a first one side constant width part which is a region ranging from the first end part to the first width reduction end part, and a first other side constant width part which is a region ranging from the first body part center point to the first width reduction start part.

The first width varying part includes a first protrusion disposed in the first width reduction part, and a second protrusion disposed adjacent to the first protrusion.

The first protrusion is disposed in a center region of the first width reduction part, and the second protrusion is interposed between the first protrusion and the first width reduction end part, and spacing between the first protrusion and the second protrusion is maintained equal to or greater than the width of the elastic member in the first width maintaining part.

Furthermore, the varying width elastic member has the second elastic member region which includes a second body part extending in a second direction from the center part of the elastic member; a second end part formed at an end of the second body part; and a second body part center point which is a center of a length of the second body part, a region ranging from the center part to the second body part center point is a second width maintaining part, and a region ranging from the second end part to the second body part center point is a second width varying part, the second width varying part includes a second width reduction part, and the second width reduction part starts a reduction of a width of the elastic member at a second width reduction start part and ends the reduction of the width of the elastic member at a second width reduction end part, and the second width reduction part has a length of 80±5 mm.

Furthermore, the second width varying part includes a second one side constant width part which is a region ranging from the second end part to the second width reduction end part, and a second other side constant width part which is a region ranging from the second body part center point to the second width reduction start part, the second width varying part includes a third protrusion disposed in the second width reduction part, and a fourth protrusion disposed adjacent to the third protrusion, and the third protrusion is disposed in a center region of the second width reduction part, and the fourth protrusion is interposed between the third protrusion and the second width reduction end part, and spacing between the third protrusion and the fourth protrusion is maintained equal to or greater than the width of the elastic member in the second width maintaining part.

According to the present inventive concept, the elastic member having a curvature applied thereto depending on the length thereof may enable the pressing pressure to be uniformly distributed in the lengthwise direction of the wiper blade assembly.

### BRIEF DESCRIPTION OF THE DRAWINGS

FIG. 1 is a perspective view illustrating a wiper blade assembly according to the present inventive concept;

FIG. 2 is an exploded perspective view illustrating a wiper blade assembly according to the present inventive concept;

FIG. 3 is a perspective view illustrating an elastic member according to a first embodiment of the present inventive concept;

FIG. 4 is a top plan view illustrating the elastic member according to the first embodiment of the present inventive concept;

FIG. 5 is a top plan view illustrating an elastic member according to a second embodiment of the present inventive concept;

FIG. 6 is a top plan view illustrating an elastic member according to a third embodiment of the present inventive concept;

FIG. 7 is a schematic view illustrating curvatures of a general elastic member;

FIG. 8 illustrates a variation of a curvature depending on to a length of an elastic member;

FIG. 9 illustrates distribution of pressing pressure in an elastic member of a general flat type wiper blade assembly;

FIG. 10 illustrates distribution of pressing pressure in an elastic member of a wiper blade assembly according to the first embodiment of the present inventive concept;

FIG. 11 illustrates distribution of pressing pressure in an elastic member of a wiper blade assembly according to the second embodiment of the present inventive concept;

FIG. 12 illustrates distribution of pressing pressure in an elastic member of a wiper blade assembly according to a first comparative example;

FIG. 13 illustrates distribution of pressing pressure in an elastic member of a wiper blade assembly according to a second comparative example;

FIG. 14 illustrates distribution of pressing pressure in an elastic member of a wiper blade assembly according to a third comparative example;

FIG. 15 illustrates distribution of pressing pressure in the elastic member of the wiper blade assembly of FIG. 10 according to a first modified example;

FIG. 16 illustrates distribution of pressing pressure in an elastic member according to a comparative example to the first modified example shown in FIG. 15;

FIG. 17 illustrates distribution of pressing pressure in the elastic member of the wiper blade assembly of FIG. 10 according to a second modified example; and

FIG. 18 illustrates distribution of pressing pressure in an elastic member according to a comparative example to the second modified example shown in FIG. 17.

### DETAILED DESCRIPTION OF THE EMBODIMENTS

The advantages and features of the present inventive concept and methods for accomplishing the same will become apparent by describing in detail preferred embodiments thereof with reference to the attached drawings. However, this invention may, however, be embodied in different forms and should not be construed as limited to the embodiments set forth herein. Rather, these embodiments are provided so that this disclosure will be thorough and complete, and will fully convey the scope of the invention to those skilled in the art. The present inventive concept is only defined by the scope of the appended claims.

Hereinafter, preferred embodiments of the present inventive concept will be described in detail with reference to the accompanying drawings. The same reference numbers indicate the same components throughout the specification, and the term “and/or” encompasses each and every one or more combinations of the items disclosed herein.

The terms ‘first’, ‘second’, etc. may be used to describe various components, but the components are not limited by such terms. The terms are used only for the purpose of distinguishing one component from other components. Thus, a first component mentioned below may be designated as a second component within the technical idea of the present inventive concept.

The terminology used herein is for the purpose of describing particular embodiments only and is not intended to limit the inventive concept. As used herein, the singular forms are intended to include the plural forms as well, unless the context clearly indicates otherwise. It will be further understood that the terms such as “comprises” and/or “comprising” when used in this specification do not preclude the presence or addition of one or more other components besides those discussed herein.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, will not be interpreted in an idealized or overly formal sense unless expressly so defined herein.

Spatially relative terms, such as “below,” “beneath,” “lower,” “above,” “upper” and the like, may be used herein for ease of description of the relationship between one element and other elements as illustrated in the drawings. Spatially relative terms may be intended to encompass different orientations of the components in use or in operation in addition to the orientation depicted in the drawings. For example, if components depicted in the drawings are turned over, elements described as “below” or “beneath” other elements would then be oriented “above” the other elements. Thus, the exemplary term “below” can encompass both orientations of above and below. The component can be otherwise oriented, and the spatially relative terms used herein interpreted accordingly.

Exemplary embodiments of the present inventive concept will now be explained with reference to the attached drawings.

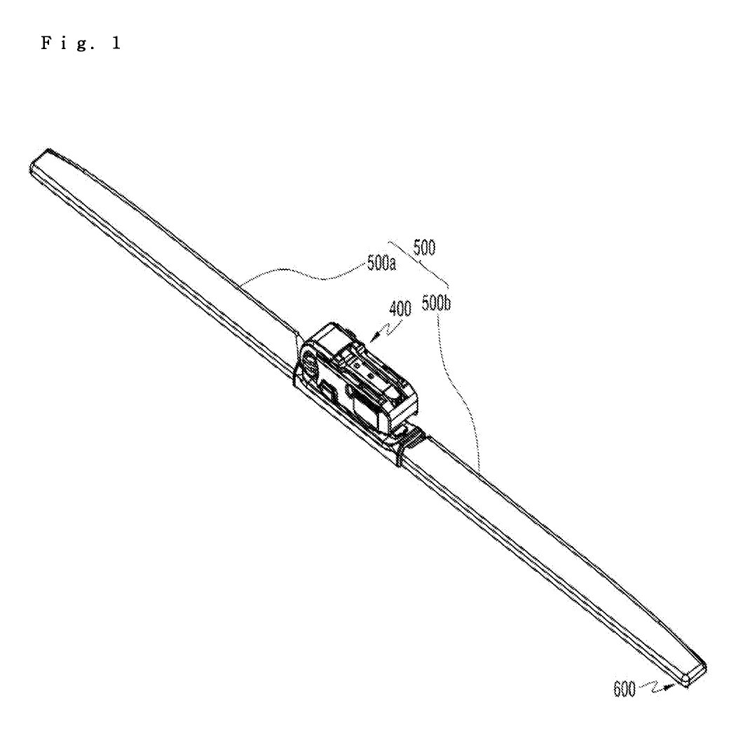

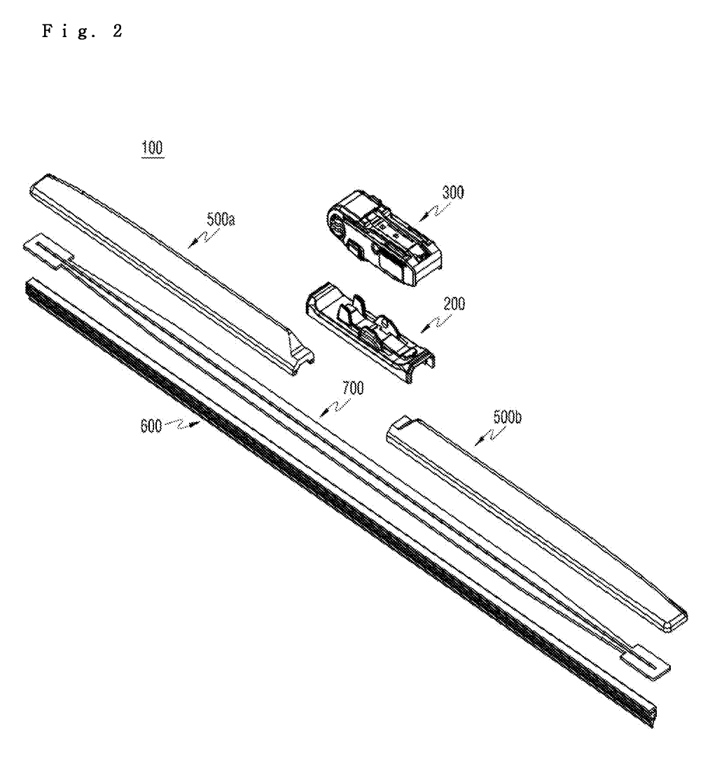

FIG. 1 is a perspective view illustrating a wiper blade assembly according to the present inventive concept, and FIG. 2 is an exploded perspective view illustrating a wiper blade assembly according to the present inventive concept.

Referring to FIG. 1 and FIG. 2, a wiper blade assembly 100 according to the present inventive concept may include a tight contact member 600 made of a rubber material and contacting a vehicular windshield, an elastic member 700 comprised of pre-stressed steel supporting the tight contact member 600 or rubber wiper lip, a cover member 500 including a pair of cover members 500a and 500b to which the elastic member 700 is inserted, and a joint cover 200 provided in a predetermined region of the wiper blade assembly in a lengthwise direction and including an accommodation part.

The wiper blade assembly 100 according to the present inventive concept may further include an adaptor 300 connectible/removable to/from the accommodation part of the joint cover 200.

Although not shown in the drawings, a wiper arm may be coupled to the adaptor 300 so as to enable the wiper blade assembly 100 to perform wiping operation by the power transmitted from the wiper arm.

In this case, as shown in the drawings, the joint cover 200 may be disposed in the center region of the wiper blade assembly 100 in the lengthwise direction, and thus the adaptor 300 connectible/removable to/from the accommodation part of the joint cover 200 may also be disposed in the center region of the wiper blade assembly 100 in the lengthwise direction.

The wiper arm (not shown) may be coupled to the adaptor 300, and the wiper blade assembly 100 may perform wiping operation by a driving force of the wiper arm.

In this case, since the adaptor 300 coupled to the wiper arm may be disposed in the center region of the wiper blade assembly 100 in the lengthwise direction, the wiper arm may press the wiper blade assembly 100 in the center region of the wiper arm in the lengthwise direction.

The wiper blade assembly 100 may tightly contact a vehicular windshield by the pressing pressure of the wiper arm, and excellent contact characteristics between the wiper blade assembly 100 and the vehicular windshield are required in order to improve wiping properties of the wiper blade assembly 100.

Therefore, it is important to make the pressing pressure applied to the wiper blade assembly 100 by the wiper arm as uniformly distributed as possible. However, a general flat type wiper blade assembly has a defect in that the pressing pressure applied from the wiper arm becomes weaker toward ends of the wiper blade assembly from the center thereof, causing non-uniformity in the distribution of the pressing pressure in the lengthwise direction of the wiper blade assembly.

The present inventive concept is developed to address these problems and provide a wiper blade assembly in which the width of the elastic member 700 is varied or adjusted to allow pressing pressure applied thereto to be more uniformly distributed overall as shown herein.

The elastic member of the present inventive concept will hereinafter be described.

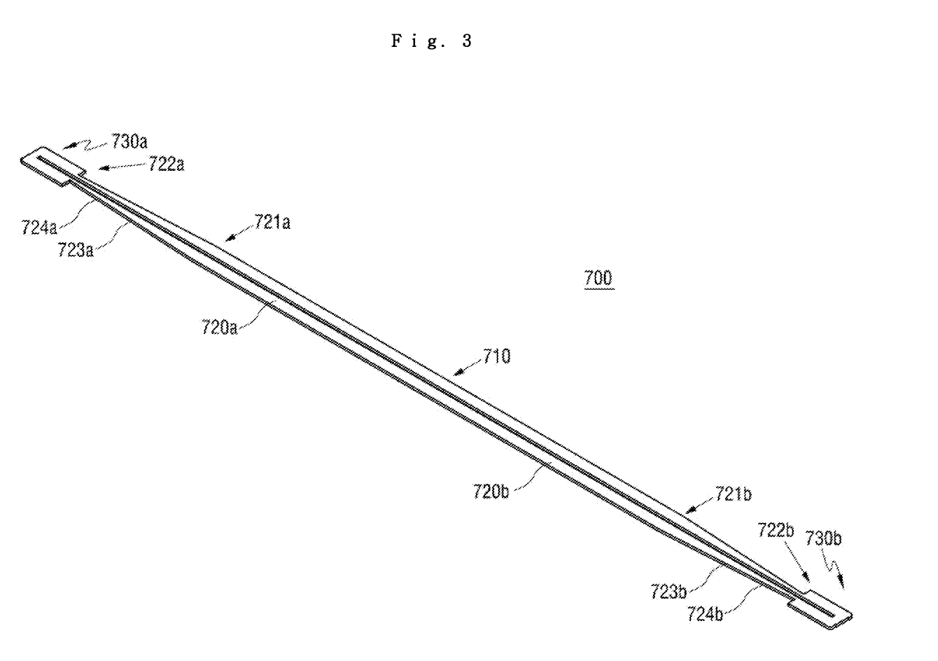

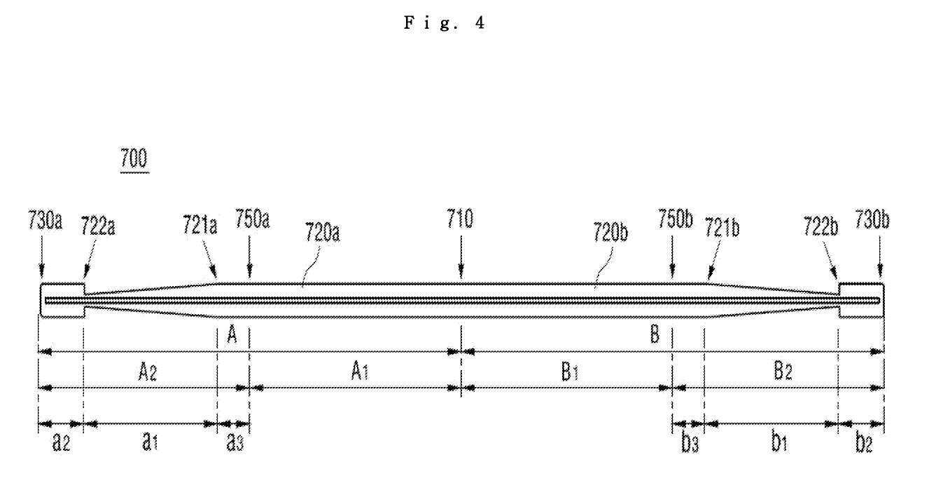

FIG. 3 is a perspective view illustrating an elastic member according to a first embodiment of the present inventive concept, and FIG. 4 is a top plan view illustrating the elastic member according to the first embodiment of the present inventive concept.

Referring to FIG. 3 and FIG. 4, the varying width elastic member 700 of the first embodiment of the present inventive concept may include a center part 710, a first body part 720a extending in the first direction from the center part 710, and a first end part 730a disposed at an end of the first body part 720a.

The varying width elastic member 700 of the first embodiment of the present inventive concept may further include a second body part 720b extending in the second direction from the center part 710, and a second end part 730b disposed at an end of the second body part 720b.

That is, the elastic member of the present inventive concept can be defined as the center part 710, end parts 730a and 730b disposed at the respective ends about the center part 710, and body parts 720a and 720b interposed respectively between the center part 710 and the end parts 730a and 730b.

On the basis of the definition, as shown in FIG. 4, the region ranging from the center part 710 to the first end part 730a passing through the first body part 720a can be defined as a first elastic member region A, and the region ranging from the center part 710 to the second end part 730b passing through the second body part 720b can be defined as a second elastic member region B.

Since the first elastic member region A and the second elastic member region B may be symmetrical to each other about the center part 710, the description of the present inventive concept will hereinafter be made on the first elastic member region A, which can also be applied to the second elastic member region B, although non-symmetric designs may be contemplated in accordance with the teachings of the present invention and would fall within the scope of the present invention.

Referring to FIG. 4 of the varying width elastic member 710, when one-half point of the distance from the center part 710 to the first end part 730a, that is, one-half point of the length of the first body part 720a is defined as a first body part center point 750a, the first elastic member region A may include a first width maintaining part A1 which is a region ranging from the center part 710 to the first body part center point 750a, and a first width varying part A2 which is a region ranging from the first end part 730a to the first body part center point 750a.

In this case, the width maintaining part may mean a region in which the width of the elastic member is maintained constant without change, and the width varying part may mean a region in which the width of the elastic member changes and thus is not maintained constant.

The first width varying part A2 may include a first width reduction part a1, and the first width reduction part a1 may include a first width reduction start part 721a and a first width reduction end part 722a.

That is, reduction of the width of the elastic member starts at the first width reduction start part 721a of the first width reduction part a1 and ends at the first width reduction end part 722a of the first width reduction part a1.

In this case, the first width reduction part a1 has a length of 80±5 mm.

That is, the length of the first width reduction part a1 may be 75 to 85 mm in the first elastic member region A.

The present inventive concept is characterized in that the length of the first width reduction part a1 being 80±5 mm can be applied regardless of the length of the elastic member which will be described later.

The length of the first width reduction part a1 being 80±5 mm will be described later.

Still referring to FIG. 4, the first width varying part A2 may include a constant width part in a region other than the first width reduction part a1, like regions a2 and a3 shown in FIG. 4.

More specifically, the first width varying part A2 may include first constant width parts a2 and a3 respectively at one end and the other end of the first width reduction part a1, and still more specifically, the first width varying part A2 may include the first one side constant width part a2 which is a region ranging from the first end part 730a to the first width reduction end part 722a, and the first other side constant width part a3 which is a region ranging from the first body part center point 750a to the first width reduction start part 721a.

That is, unlike the first width reduction part a1, the first one side constant width part a2 and the first other side constant width part a3 are regions where the width of the elastic member is not reduced, and thus the first one side constant width part a2 and the first other side constant width part a3 can maintain the width of the elastic member same as that in the first width maintaining part A1.

In the present inventive concept, the length of the first width reduction part a1 can be adjusted to 80±5 mm through the first one side constant width part a2 and the first other side constant width part a3, that is, lengths of the first one side constant width part a2 and the first other side constant width part a3 can be adjusted so as to adjust the length of the first width reduction part a1 to 80±5 mm.

As described above, the present inventive concept is characterized in that the first elastic member region A includes the first width maintaining part A1 which is a region ranging from the center part 710 to the first body part center point 750a, and the first width varying part A2 which is a region ranging from the first end part 730a to the first body part center point 750a, that is, the first width reduction part a1 where the width of the elastic member is reduced is disposed in the region ranging from the first end part 730a to the first body part center point 750a.

That is, in the preferred embodiment of the present inventive concept, the width reduction part where the width of the elastic member is reduced may be absent in the region ranging from the center part 710 to the first body part center point 750a, which will be described later.

Still referring to FIG. 4, when one-half point of the distance from the center part 710 to the second end part 730b, that is, one-half point of the length of the second body part 720b is defined as a second body part center point 750b, the second elastic member region B may include a second width maintaining part B1 which is a region ranging from the center part 710 to the second body part center point 750b, and a second width varying part B2 which is a region ranging from the second end part 730b to the second body part center point 750b.

In this case, the width maintaining part may mean a region in which the width of the elastic member is maintained constant without change, and the width varying part may mean a region in which the width of the elastic member changes and thus is not maintained constant.

The second width varying part B2 may include a second width reduction part b1, and the second width reduction part b1 may include a second width reduction start part 721b and a second width reduction end part 722b.

That is, reduction of the width of the elastic member starts at the second width reduction start part 721b of the second width reduction part b1 and ends at the second width reduction end part 722b of the second width reduction part b1.

In this case, the second width reduction part b1 has a length of 80±5 mm.

The length of the second width reduction part b1 is the same as the length of the first width reduction part a1, and thus a detailed description thereof will be omitted.

Still referring to FIG. 4, the second width varying part B2 may include a constant width part in a region other than the second width reduction part b1, like regions b2 and b3 shown in FIG. 4.

More specifically, the second width varying part B2 may include second constant width parts b2 and b3 respectively at one end and the other end of the second width reduction part b1, and still more specifically, the second width varying part B2 may include the second one side constant width part b2 which is a region ranging from the second end part 730b to the second width reduction end part 722b, and the second other side constant width part b3 which is a region ranging from the second body part center point 750b to the second width reduction start part 721b.

This feature is the same as that of the first width varying part A2 described above, and thus a detailed description thereof will be omitted.

As described above, the present inventive concept is characterized in that the second width reduction part b1 where the width of the elastic member is reduced is disposed in the region ranging from the second end part 730b to the second body part center point 750b, and preferably, the second width reduction part b1 is absent in the region ranging from the center part 710 to the second body part center point 750b, like the first elastic member region A.

As described above, reduction of the width of the elastic member starts at the first width reduction start part 721a of the first width reduction part a1 and ends at the first width reduction end part 722a of the first width reduction part a1.

Furthermore, reduction of the width of the elastic member starts at the second width reduction start part 721b of the second width reduction part b1 and ends at the second width reduction end part 722b of the second width reduction part b1.

In the first embodiment of the present inventive concept, reduction of the width of the elastic member starts and ends may mean that the reduction rate in the width of the elastic member gradually increases.

That is, as shown in FIG. 3 and FIG. 4, the width of the elastic member in the first width reduction start part 721a of the first width reduction part a1 is different from the width of the elastic member in the first width reduction end part 722a of the first width reduction part a1, and still more specifically, the first width reduction part a1 may be structured in such a manner that the width of the elastic member in the first width reduction end part 722a is narrower than the width of the elastic member in the first width reduction start part 721a.

The second width reduction part b1 is structured in the same manner, and thus a detailed description thereof will be omitted.

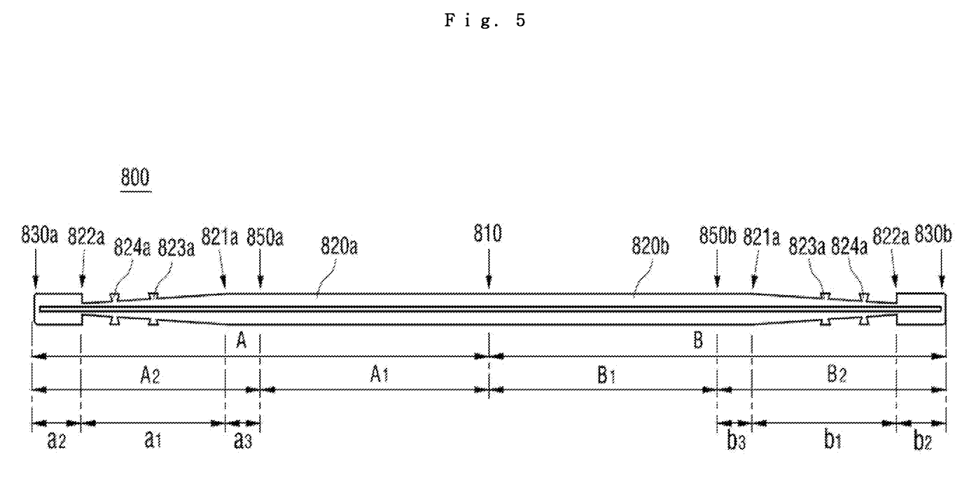

FIG. 5 is a top plan view illustrating an varying width elastic member according to a second embodiment of the present inventive concept. The elastic member of the second embodiment of the present inventive concept may be the same as the elastic member of the first embodiment described above, except the features described below.

Referring to FIG. 5, an elastic member 800 of the second embodiment of the present inventive concept may include a center part 810, a first body part 820a extending in the first direction from the center part 810, and a first end part 830a disposed at an end of the first body part 820a.

The elastic member 800 of the second embodiment of the present inventive concept may further include a second body part 820b extending in the second direction from the center part 810, and a second end part 830b disposed at an end of the second body part 820b.

As shown in FIG. 5, the region ranging from the center part 810 to the first end part 830a passing through the first body part 820a can be defined as a first elastic member region A, and the region ranging from the center part 810 to the second end part 830b passing through the second body part 820b can be defined as a second elastic member region B.

The definition of the first elastic member region A and the second elastic member region B is the same as that of the first embodiment, and thus a detailed description thereof will be omitted.

Like those of the first embodiment, a first body part center point 850a, a second body part center point 850b, a first width reduction start part 821a, a first width reduction end part 822a, a second width reduction start part 821b, a second width reduction end part 822b, and the like can also be defined in the elastic member 800 of the second embodiment of the present inventive concept.

The first embodiment and the second embodiment of the present inventive concept differ from each other with respect to the first width reduction part a1 of the first width varying part A2 and the second width reduction part b1 of the second width varying part B2.

As described above, in the second embodiment of the present inventive concept, the first width varying part A2 may include a first protrusion 823a disposed in the first width reduction part a1, and a second protrusion 824a disposed adjacent to the first protrusion 823a, and the second width varying part B2 may include a third protrusion 823b disposed in the second width reduction part b1, and a fourth protrusion 824b disposed adjacent to the third protrusion 823b.

The first to fourth protrusions may be disposed in the respective width reduction parts so as to support the cover member. The protrusions according to the second embodiment of the present inventive concept will hereinafter be described.

Referring to FIG. 5, the first width varying part A2 of the elastic member 800 of the second embodiment of the present inventive concept may include the first protrusion 823a disposed in the first width reduction part a1, and the second protrusion 824a disposed adjacent to the first protrusion 823a.

The first protrusion 823a and the second protrusion 824a may be disposed in the first width reduction part a1 so as to support the cover member 500.

That is, since the width of the elastic member 800 is reduced in the first width reduction part a1, the cover member 500 cannot be supported in the region of the first width reduction part a1 when the cover member 500 and the elastic member 800 are coupled to each other, but the first protrusion 823a and the second protrusion 824a serve to support the cover member 500.

However, as the number of the protrusions increases, characteristics to support the cover member will be improved, but this is contrary to the feature of present inventive concept of having the width reduction part, and thus it is preferable to have a minimum number of protrusions.

For example, as shown in FIG. 5, the first protrusion 823a may be disposed in the center region of the first width reduction part a1, and the second protrusion 824a may be interposed between the first protrusion 823a and the first width reduction end part 822a, and it is preferable to maintain spacing between the first protrusion 823a and the second protrusion 824a equal to or greater than the width of the elastic member in the first width maintaining part A1. This will be described later.

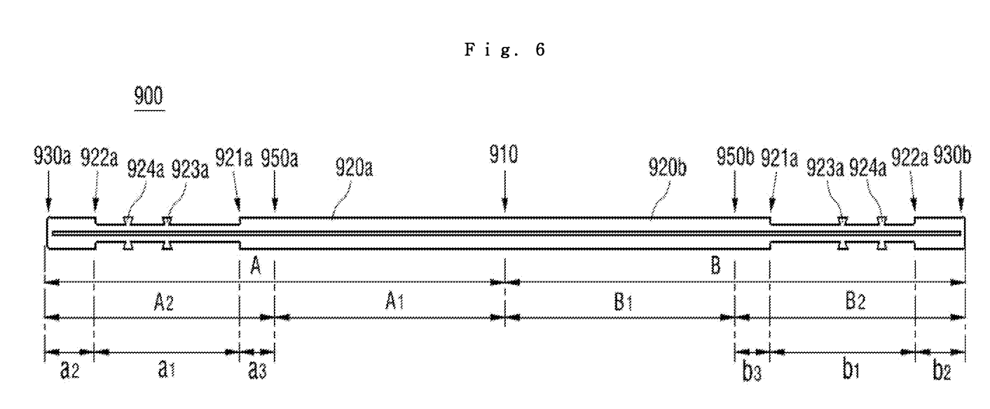

As shown in FIG. 6, the second width varying part B2 of the elastic member 800 of the second embodiment of the present inventive concept may include the third protrusion 823b disposed in the second width reduction part b1, and the fourth protrusion 824b disposed adjacent to the third protrusion 823b.

In this case, the third protrusion 823b may be disposed in the center region of the second width reduction part b1, and the fourth protrusion 824b may be interposed between the third protrusion 823b and the second width reduction end part 822b, and it is preferable to maintain spacing between the third protrusion 823b and the fourth protrusion 824b equal to or greater than the width of the elastic member in the second width maintaining part B1.

This feature is the same as that of the first width varying part A2, and thus a detailed description thereof will be omitted.

However, in the present inventive concept, the protrusions are provided to achieve the purpose and effect of supporting the cover member, and the essential purpose of the present inventive concept of providing a wiper blade assembly having a uniform distribution of pressing pressure can be achieved even without the protrusions. Thus, the protrusions described above can be omitted depending on the construction and the application of the present invention.

FIG. 6 is a top plan view illustrating an elastic member according to a third embodiment of the present inventive concept. The elastic member of the third embodiment of the present inventive concept may be the same as the elastic members of the first and second embodiments described above, except the features described below.

Referring to FIG. 6, an elastic member 900 of the third embodiment of the present inventive concept may include a center part 910, a first body part 920a extending in the first direction from the center part 910, and a first end part 930a disposed at an end of the first body part 920a.

The elastic member 900 of the third embodiment of the present inventive concept may further include a second body part 920b extending in the second direction from the center part 910, and a second end part 930b disposed at an end of the second body part 920b.

As shown in FIG. 6, the region ranging from the center part 910 to the first end part 930a passing through the first body part 920a can be defined as a first elastic member region A, and the region ranging from the center part 910 to the second end part 930b passing through the second body part 920b can be defined as a second elastic member region B.

The definition of the first elastic member region A and the second elastic member region B is the same as that of the first embodiment, and thus a detailed description thereof will be omitted.

Like those of the first embodiment, a first body part center point 950a, a second body part center point 950b, a first width reduction start part 921a, a first width reduction end part 922a, a second width reduction start part 921b, a second width reduction end part 922b, and the like can also be defined in the elastic member 900 of the third embodiment of the present inventive concept.

The first embodiment, the second embodiment, and the third embodiment of the present inventive concept differ from each other with respect to the first width reduction part a1 of the first width varying part A2 and the second width reduction part b1 of the second width varying part B2, and the difference will hereinafter be described on the basis of the first embodiment.

As described above with reference to FIG. 3 and FIG. 4, in the first embodiment of the present inventive concept, reduction of the width of the elastic member starts at the first width reduction start part 721a of the first width reduction part a1 and ends at the first width reduction end part 722a of the first width reduction part a1.

Furthermore, in the first embodiment of the present inventive concept, reduction of the width of the elastic member starts at the second width reduction start part 721b of the second width reduction part b1 and ends at the second width reduction end part 722b of the second width reduction part b1.

This feature is the same in the third embodiment of the present inventive concept.

In the first embodiment of the present inventive concept, the width of the elastic member in the first width reduction start part 721a of the first width reduction part a1 is different from the width of the elastic member in the first width reduction end part 722a of the first width reduction part a1, and still more specifically, the first width reduction part a1 may be structured in such a manner that the width of the elastic member in the first width reduction end part 722a is narrower than the width of the elastic member in the first width reduction start part 721a.

However, in the third embodiment of the present inventive concept, as shown in FIG. 6, the width of the elastic member in the first width reduction start part may be the same as the width of the elastic member in the first width reduction end part, that is, the width of the elastic member may be reduced equally throughout the first width reduction part.

This feature is the same in the second width reduction part, and thus a detailed description thereof will be omitted.

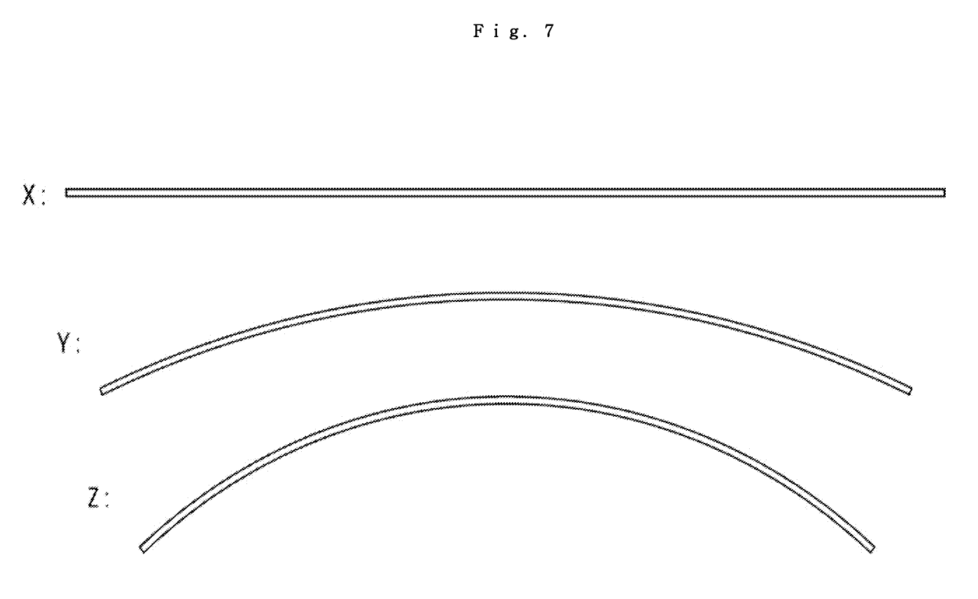

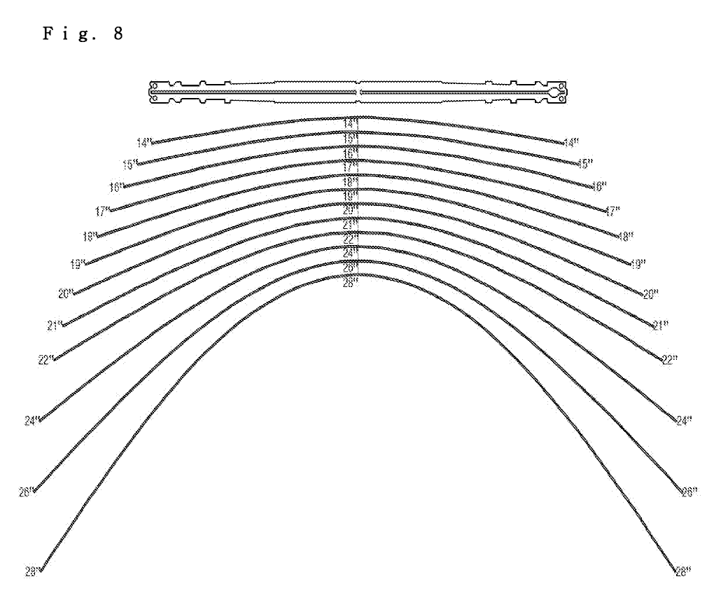

FIG. 7 is a schematic view illustrating curvatures of a general elastic member, and FIG. 8 illustrates a variation of a curvature depending on a length of an elastic member.

As shown in FIG. 7, an elastic member may have no curvature as shown in X, or may have different curvatures as shown in X and Y.

Wiper blade assemblies can be roughly classified into a conventional type and a flat type according to the structure of a blade, and flat type wiper blades generally have elastic members with curvatures.

Flat type wiper blades have elastic members with curvatures so as to enable the pressing pressure applied to a wiper arm to be uniformly distributed, and generally, curvatures are different from each other depending on the length of the elastic member.

FIG. 8 illustrates a curvature variation in an elastic member depending on the length of the elastic member.

Table 1 below shows k values for the respective inches, wherein k=1/R, and R indicates a curvature in a center part of an elastic member as determined from the present invention.

TABLE 1

| Inch | k |
|---|---|
| 14 | 0.0020 |
| 15 | 0.0023 |
| 16 | 0.0025 |
| 17 | 0.0028 |
| 18 | 0.0032 |
| 19 | 0.0035 |
| 20 | 0.0038 |
| 21 | 0.0042 |
| 22 | 0.0046 |
| 24 | 0.0054 |
| 26 | 0.0063 |
| 28 | 0.0072 |

On the basis of Table 1 above, k value for each range of the length of the elastic member can be defined as follows.

When the length of the elastic member is 14 to 17 inches, k values in this range can be defined as 0.0020 to 0.0028, and when the length of the elastic member is 18 to 20 inches, k values in this range can be defined as 0.0032 to 0.0038.

When the length of the elastic member is 21 to 22 inches, k values in this range can be defined as 0.0042 to 0.0046, and when the length of the elastic member is 24 to 28 inches, k values in this range can be defined as 0.0054 to 0.0072.

A relation between the curvature values for the respective inches and the width reduction section according to the present inventive concept will be described below.

Experimental examples according to the present inventive concept will be described below, but the present disclosure is not limited thereto.

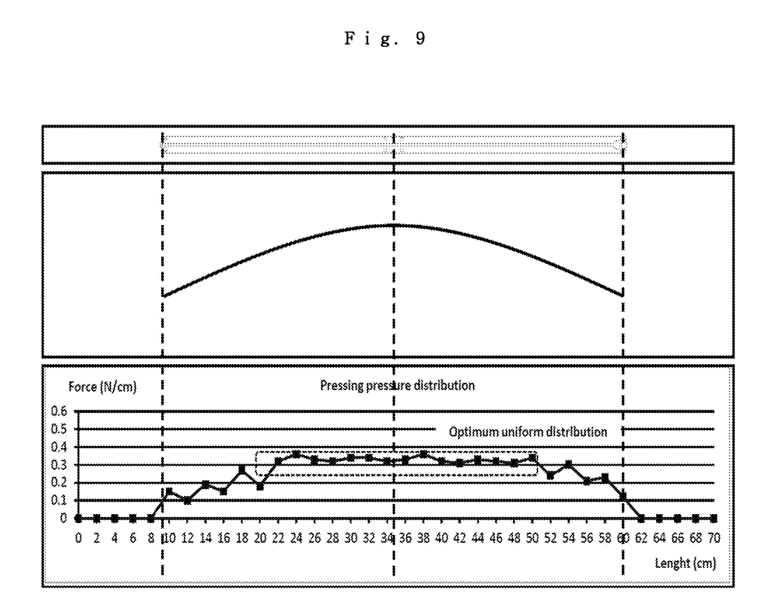

FIG. 9 illustrates distribution of pressing pressure in an elastic member of a general flat type wiper blade assembly.

Referring to FIG. 9, the elastic member has a length of 20 inches (500 mm), and k value for calculating the curvature R in the center part of the elastic member is 0.0038.

Meanwhile, referring to FIG. 9, the pressing pressure of the wiper arm is 14 gf/cm, and a pressing pressure distribution measuring device used herein is capable of measuring up to 28 inches, and thus, 100 mm in the early stage and 100 mm in the later stage are marked as zero. And, the test was performed on flat test plate of the pressing pressure distribution measuring device.

In this case, the pressing pressure can be determined as being uniform when the variation value of Force(N/cm) is 0 to 0.05, and as being non-uniform when the variation value of Force(N/cm) is higher than 0.05.

For example, when the pressing pressure of the wiper arm is 14 gf/cm, the pressing pressure distribution can be considered as being optimum when Force(N/cm) value for each section is 0.3 to 0.35.

As shown in FIG. 9, general elastic members may not have uniform distribution of pressing pressure despite that the elastic member has a certain curvature.

That is, when the length of the elastic member ranges from 22 cm to 50 cm, distribution of pressing pressure is uniform, but when the length of the elastic member ranges from 10 cm to 20 cm and 52 to 60 cm, which corresponds to an end region and a region adjacent thereto, distribution of pressing pressure is not uniform.

In a general wiper blade assembly, distribution of pressing pressure is different at the center part and end part of the wiper blade assembly, and for example, the pressing pressure applied from a wiper arm becomes weaker toward the end part from the center part, thus causing problems of non-uniform distribution of pressing pressure in the lengthwise direction of the wiper blade assembly.

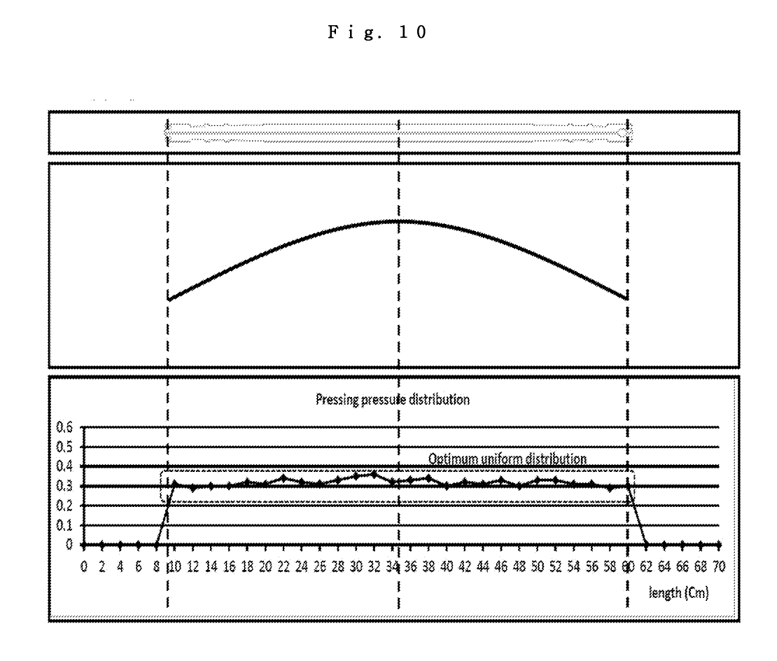

FIG. 10 illustrates distribution of pressing pressure in the elastic member of the wiper blade assembly according to the first embodiment of the present inventive concept.

Referring to FIG. 10, the elastic member has a length of 20 inches (500 mm), and k value for calculating the curvature R in the center part of the elastic member is 0.0038.

Meanwhile, referring to FIG. 10, the pressing pressure of the wiper arm is 14 gf/cm, and a pressing pressure distribution measuring device used herein is capable of measuring up to 28 inches, and thus, 100 mm in the early stage and 100 mm in the later stage are marked as zero.

In this case, the pressing pressure can be determined as being uniform when the variation value of Force(N/cm) is 0 to 0.05, and as being non-uniform when the variation value of Force(N/cm) is higher than 0.05.

For example, when the pressing pressure of the wiper arm is 14 gf/cm, the pressing pressure distribution can be considered as being optimum when Force(N/cm) value for each section is 0.3 to 0.35.

As shown in FIG. 10, the varying width elastic member of the wiper blade assembly according to the first embodiment of the present inventive concept includes the width varying part having a predetermined protrusion. In this case, as described above, the width reduction part may have a length of 80 mm, which in this particular application corresponds to a substantial portion of the overall elastic member, in this case quite substantial as it is 32% of the region of the elastic member.

That is, when the elastic member has a length of 20 inches, for example, the region of the first elastic member corresponds to 250 mm and the length of the first width reduction part corresponds to 80 mm among the total length of 500 mm of the elastic member, and thus, in the present inventive concept, the length of the first width reduction part is 32% of the region of the first elastic member.

In this case, it is considered that the same effect can be achieved when the length of the first width reduction part a1 ranges up to 80±5 mm, and thus, the length of the first width reduction part is defined as 80±5 mm. This feature is the same in the region of the second elastic member.

Still referring to FIG. 10, in the varying width elastic member of the wiper blade assembly according to the first embodiment of the present inventive concept, distribution of pressing pressure is uniform throughout the length of the elastic member of 10 to 60 cm.

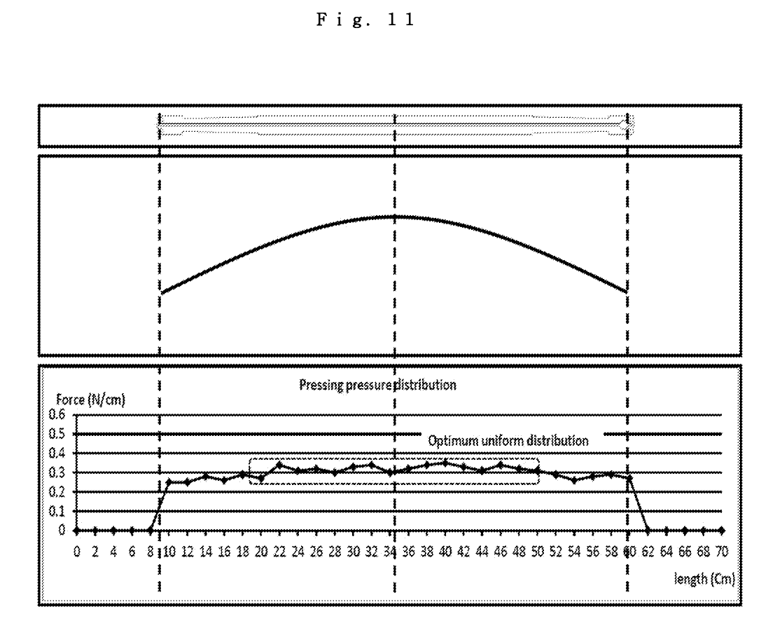

FIG. 11 illustrates distribution of pressing pressure in the elastic member of the wiper blade assembly according to the second embodiment of the present inventive concept.

Referring to FIG. 11, the elastic member has a length of 20 inches (500 mm), and k value for calculating the curvature R in the center part of the elastic member is 0.0038. Other conditions are the same as those of the first embodiment, and thus a detailed description thereof will be omitted.

As shown in FIG. 11, the varying width elastic member of the wiper blade assembly according to the second embodiment of the present inventive concept includes the width varying part having no protrusion. This is the same as those described above, and thus a detailed description thereof will be omitted.

Referring to FIG. 11, in the elastic member of the wiper blade assembly according to the second embodiment of the present inventive concept, optimum uniform distribution of pressing pressure can be obtained when the length of the elastic member is 20 to 50 cm. Pressing pressure is slightly lowered when the length of the elastic member is 10 to 20 cm or 52 to 60 cm, but the distribution of pressing pressure is uniform throughout the range of 10 to 60 cm.

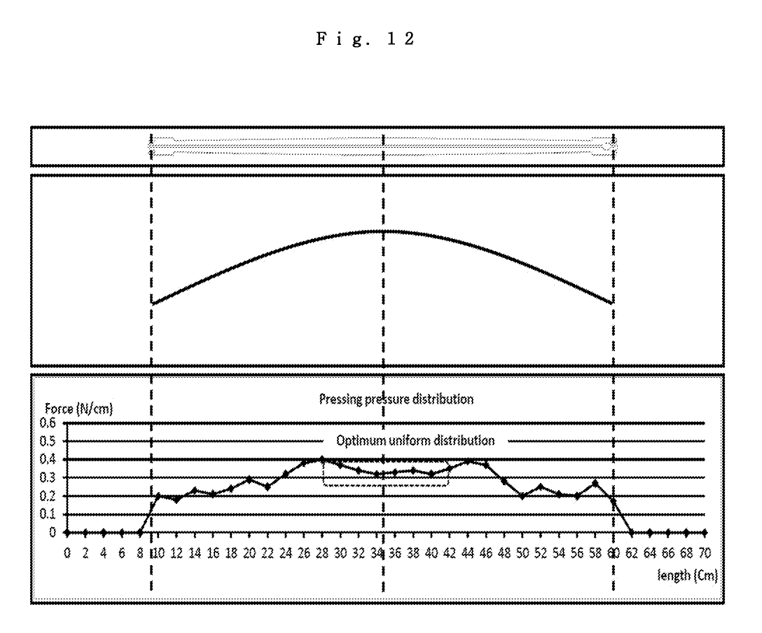

FIG. 12 illustrates distribution of pressing pressure in an elastic member of a wiper blade assembly according to a first comparative example.

Referring to FIG. 12, the elastic member of the first comparative example has a length of 20 inches (500 mm), and k value for calculating the curvature R in the center part of the elastic member is 0.0038. Other conditions are the same as those of the first embodiment, and thus a detailed description thereof will be omitted.

As shown in FIG. 12, the elastic member in the wiper blade assembly according to the first comparative example has a width reduction section except in a center part thereof.

That is, referring to FIG. 4, it is understood that the width of the elastic member is reduced throughout A1, a1, a3, B1, b1 and b3 regions.

Referring to FIG. 12, distribution of pressing pressure is non-uniform throughout the elastic member in the wiper blade assembly according to the first comparative example, and the distribution of pressing pressure is more non-uniform as compared with the elastic member described with reference to FIG. 9 having no width reduction section.

This indicates that a width reduction section will not necessarily result in a uniform distribution of pressing pressure.

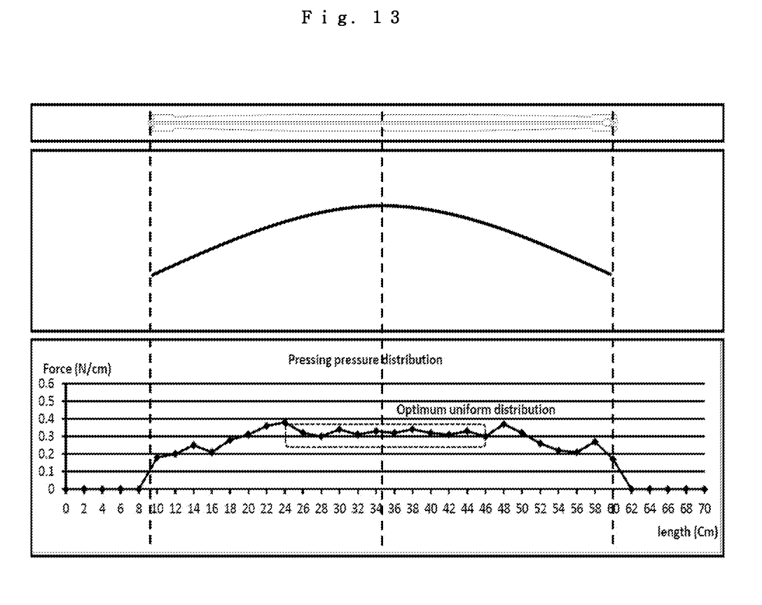

FIG. 13 illustrates distribution of pressing pressure in an elastic member of a wiper blade assembly according to a second comparative example.

Referring to FIG. 13, the elastic member of the second comparative example has a length of 20 inches (500 mm), and k value for calculating the curvature R in the center part of the elastic member is 0.0038. Other conditions are the same as those of the first embodiment, and thus a detailed description thereof will be omitted.

As shown in FIG. 13, a width reduction section is set starting from one-half point of a length of a body part, that is, a center point of the body part in the elastic member in the wiper blade assembly according to the second comparative example.

That is, referring to FIG. 4, it is understood that the width of the elastic member is reduced throughout a1, a3, B1, b1 and b3 regions.

Referring to FIG. 13, distribution of pressing pressure is non-uniform throughout the elastic member in the wiper blade assembly according to the second comparative example, and the distribution of pressing pressure is more non-uniform as compared with the elastic member described with reference to FIG. 9 having no width reduction section.

The result shown in FIG. 13 also indicates that a width reduction section will not necessarily result in a uniform distribution of pressing pressure.

To determine from results shown in FIG. 12 and FIG. 13, when one-half point of the distance from the center part 710 to the first end part 730a, that is, one-half point of the length of the first body part 720a is defined as a first body part center point (not shown) with reference to FIG. 4, it is preferable not to dispose a width reduction section in the region ranging from the center part 710 to the first body part center point. Thus, in the present inventive concept, the region ranging from the center part 710 to the first body part center point (not shown) is set as a width maintaining part which is a region where the width of the elastic member is maintained constant without change.

That is, pressing pressure of the wiper arm is not reduced in the region ranging from the center part 710 to the first body part center point (not shown), and if a width reduction section is disposed in the region, the region will be further pressed due to the reduced width in the state where the pressing pressure is not reduced, resulting in an increased non-uniformity in the distribution of the pressing pressure.

Thus, in the present inventive concept described above with reference to FIG. 3 and FIG. 4, the first elastic member region A may include the first width maintaining part A1 which is a region ranging from the center part 710 to the first body part center point (not shown), and the first width varying part A2 which is a region ranging from the first end part 730a to the first body part center point (not shown).

This feature is the same in the second elastic member region B, and thus a detailed description thereof will be omitted.

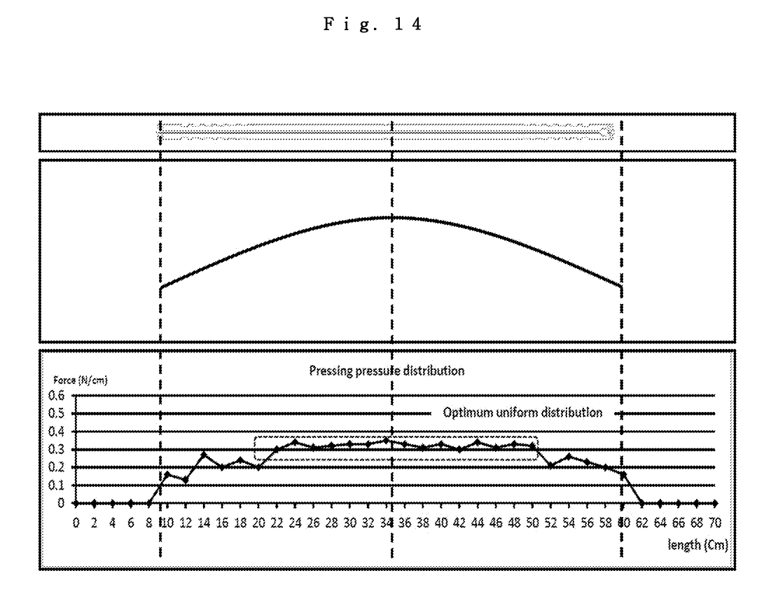

FIG. 14 illustrates distribution of pressing pressure in an elastic member of a wiper blade assembly according to a third comparative example.

Referring to FIG. 14, the elastic member of the third comparative example has a length of 20 inches (500 mm), and k value for calculating the curvature R in the center part of the elastic member is 0.0038. Other conditions are the same as those of the first embodiment, and thus a detailed description thereof will be omitted.

As shown in FIG. 14, the elastic member in the wiper blade assembly according to the third comparative example has protrusions formed throughout a width reduction section thereof while being provided with other conditions same as those of the first embodiment.

In the first embodiment described with reference to FIG. 4, the first protrusion 723a is disposed in the center region of the first width reduction part a1, and the second protrusion 724a is interposed between the first protrusion 723a and the first width reduction end part 722a, and spacing between the first protrusion 723a and the second protrusion 724a is maintained equal to or greater than the width of the elastic member in the first width maintaining part A1.

However, in the third comparative example, a plurality of protrusions are disposed all over the whole region of the width reduction part with no consideration of spacing.

Referring to FIG. 14, in the elastic member in the wiper blade assembly according to the third comparative example, optimum uniformity in the distribution of pressing pressure can be obtained when the length of the elastic member is 20 to 50 cm, but the distribution of pressing pressure is non-uniform when the length of the elastic member is 10 to 20 cm or 52 to 60 cm.

However, as the number of the protrusions increases, characteristics to support the cover member will be improved, but this is contrary to the feature of present inventive concept of having the width reduction part, and thus it is preferable to have a minimum number of protrusions.

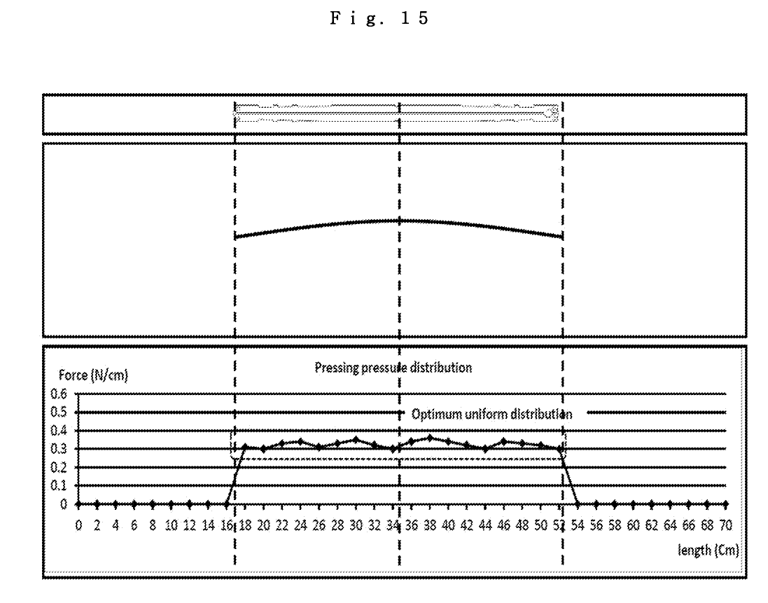

FIG. 15 illustrates distribution of pressing pressure in the elastic member of the wiper blade assembly of FIG. 10 according to a first modified example.

Conditions provided to the first modified example of FIG. 15 are the same as those of FIG. 10 except the condition described below.

The varying width elastic member of the first modified example shown in FIG. 15 has a length of 14 inches (350 mm), and k value for calculating the curvature R in the center part of the elastic member is 0.0020.

Referring to FIG. 15, the pressing pressure of the wiper arm is 14 gf/cm, and a pressing pressure distribution measuring device used herein is capable of measuring up to 28 inches.

As shown in FIG. 15, the elastic member of the wiper blade assembly includes a width varying part having some protrusions. In this case, as described above, the width reduction part of the present inventive concept has a length of 80 mm, which is the same as those in the wiper blade assembly described with reference to FIG. 10 wherein the elastic member has a length of 20 inches.

Referring to FIG. 15, in the elastic member of the first modified example modified from the wiper blade assembly shown in FIG. 10, distribution of pressing pressure is uniform all over the whole range of the elastic member length 18 to 52 cm.

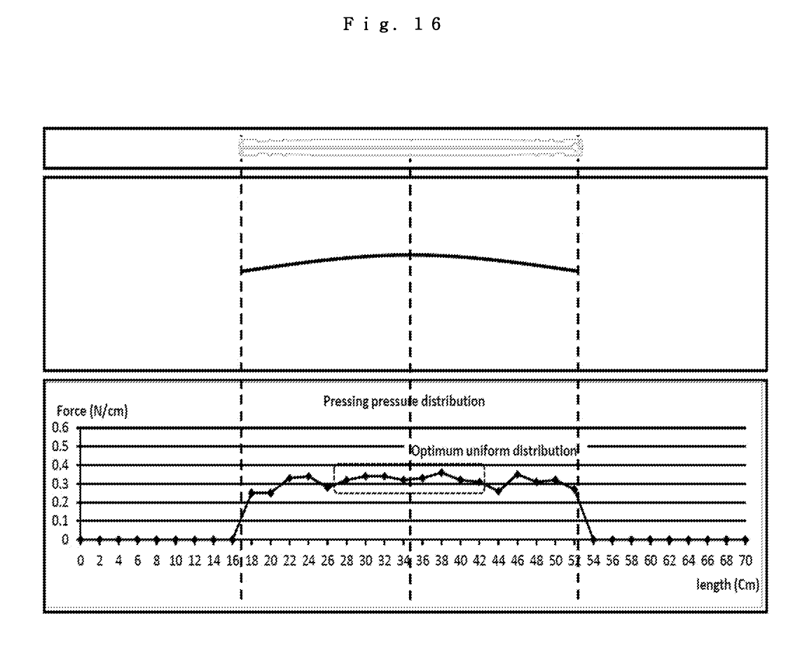

FIG. 16 illustrates distribution of pressing pressure in an elastic member according to a comparative example to the first modified example shown in FIG. 15.

Conditions provided to the comparative example of FIG. 16 are the same as those of FIG. 15 except the condition described below.

The elastic member of the comparative example shown in FIG. 16 has a length of 14 inches (350 mm), and k value for calculating the curvature R in the center part of the elastic member is 0.0020.

The length of the width reduction part is set to 80 mm in the example shown in FIG. 15, which is the same as those in the wiper blade assembly described with reference to FIG. 10 wherein the elastic member has a length of 20 inches, however, the width reduction part in FIG. 16 has a length set at the same rate rather than being set to have the same length of the width reduction part.

That is, the width reduction part is set to 56 mm in FIG. 16, and when the elastic member has a length of 14 inches, the first elastic member region occupies 175 mm and the first width reduction part length occupies 56 mm for example among the total length 350 mm of the elastic member length, and thus the first width reduction part length is 32% of the first elastic member region.

Thus, the width reduction part length is set to 80 mm regardless of the elastic member length in FIG. 15 like those in FIG. 10, but the width reduction part length is set to 56 mm in FIG. 16, which is 32% of the first elastic member region, in proportion to the elastic member length.

Referring to FIG. 16, a low pressing pressure is applied before the width reduction section start point of the elastic member of the comparative example to the first modified example of FIG. 15, and particularly, distribution of the pressing pressure becomes unstable toward end regions. This indicates that the width reduction section should be set large in the elastic member having a small curvature.

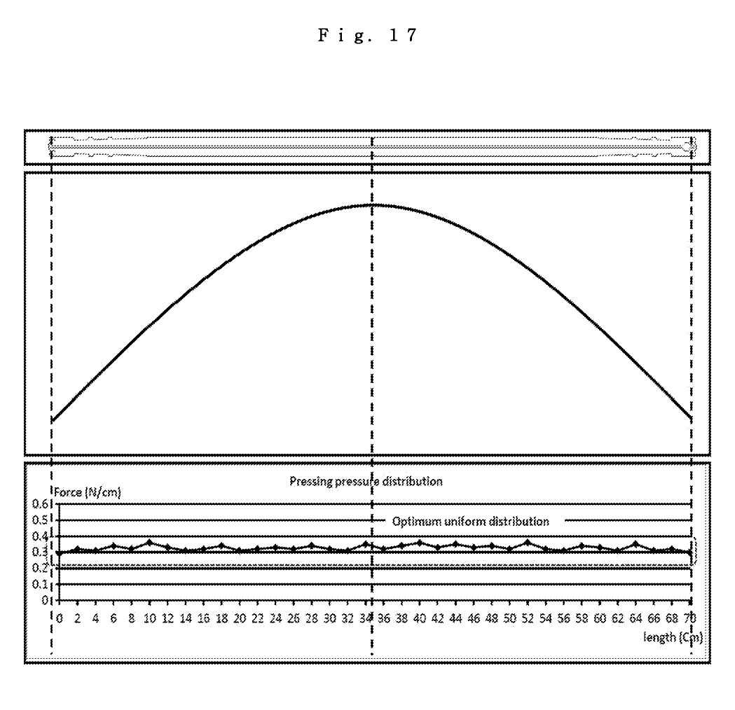

FIG. 17 illustrates distribution of pressing pressure in the elastic member of the wiper blade assembly of FIG. 10 according to a second modified example.

Conditions provided to the second modified example of FIG. 17 are the same as those of FIG. 10 except the condition described below.

The varying width elastic member of the second modified example shown in FIG. 17 has a length of 28 inches (700 mm), and k value for calculating the curvature R in the center part of the elastic member is 0.0072.

Referring to FIG. 17, the pressing pressure of the wiper arm is 14 gf/cm, and a pressing pressure distribution measuring device used herein is capable of measuring up to 28 inches.

As shown in FIG. 17, the elastic member of the wiper blade assembly includes a width varying part having some protrusions. In this case, as described above, the width reduction part of the present inventive concept has a length of 80 mm, which is the same as those in the wiper blade assembly described with reference to FIG. 10 wherein the elastic member has a length of 20 inches.

Referring to FIG. 17, in the elastic member of the second modified example modified from the wiper blade assembly shown in FIG. 10, distribution of pressing pressure is uniform all over the whole range of the elastic member length 0 to 70 cm.

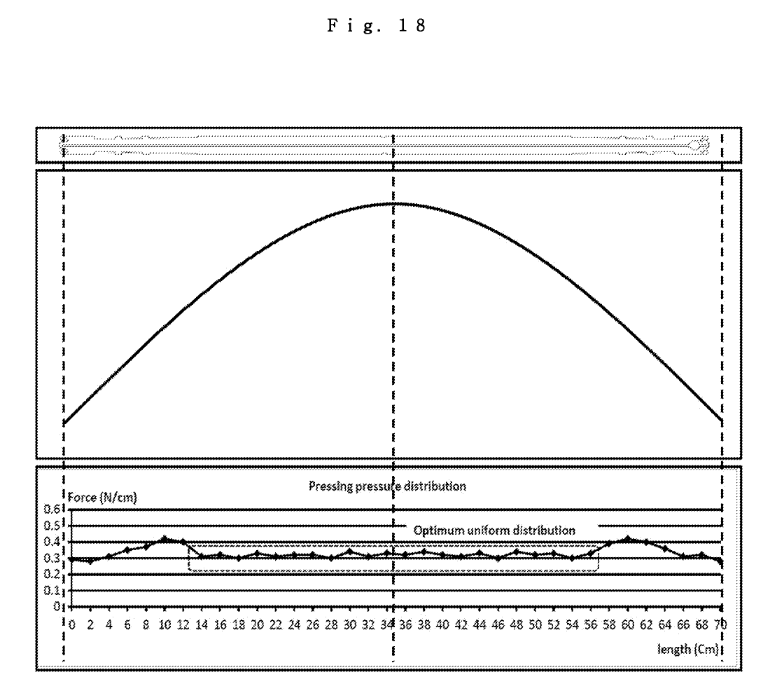

FIG. 18 illustrates distribution of pressing pressure in an elastic member according to a comparative example to the second modified example shown in FIG. 17.

Conditions provided to the comparative example of FIG. 18 are the same as those of FIG. 17 except the condition described below.

The elastic member of the comparative example shown in FIG. 18 has a length of 28 inches (700 mm), and k value for calculating the curvature R in the center part of the elastic member is 0.0072.

The length of the width reduction part is set to 80 mm in the example shown in FIG. 17, which is the same as those in the wiper blade assembly described with reference to FIG. 10 wherein the elastic member has a length of 20 inches, however, the width reduction part in FIG. 18 has a length set at the same rate rather than being set to have the same length of the width reduction part.

That is, the width reduction part is set to 112 mm in FIG. 18, and when the elastic member has a length of 28 inches, the first elastic member region occupies 350 mm and the first width reduction part length occupies 112 mm for example among the total length 700 mm of the elastic member length, and thus the first width reduction part length is 32% of the first elastic member region.

Thus, the width reduction part length is set to 80 mm regardless of the elastic member length in FIG. 17 like those in FIG. 10, but the width reduction part length is set to 112 mm in FIG. 18, which is 32% of the first elastic member region, in proportion to the elastic member length.

Referring to FIG. 18, a high pressing pressure is applied before the width reduction section start point of the elastic member of the comparative example to the second modified example of FIG. 17, and particularly, distribution of the pressing pressure becomes unstable toward end regions. This indicates that the width reduction section should be set small in the elastic member having a large curvature.

As shown in FIG. 8, the curvature of the elastic member generally varies depending on the length of the elastic member.

Contact force of a wiper blade is determined by a pressing pressure of a wiper arm and elastic force of an elastic member. When the elastic member has a large curvature, the elastic force also increases. Therefore, as a length of the elastic member increases, the curvature of the elastic member also increases. Thus, the wiper blade is designed to have uniform distribution of contact force regardless of the length of the elastic member.

However, in spite of such design, the distribution of pressing pressure is different in the center part and end parts of the wiper blade assembly as shown in the result of FIG. 9. For example, the pressing pressure applied from the wiper arm becomes weaker towards end parts from the center part, causing the problems of non-uniformity in the distribution of pressing pressure in the lengthwise direction of the wiper blade assembly.

Therefore, the present inventive concept provides a width reduction part in a predetermined section so as to achieve uniformity in the distribution of pressing pressure.

Referring to the results shown in FIG. 15 to FIG. 18, the width reduction part should increase in proportion to the length of the elastic member when the elastic member has no curvature.

However, when elastic members have optimum curvatures for the respective lengths thereof in inches, since the curvatures may become larger as the inches increase, a pressing pressure reduction part is formed in the same section regardless of inches, and thus the width reduction part should be constant regardless of inches.

In the present inventive concept, the elastic member having different curvatures depending on the lengths of elastic members are structured in a manner allowing the first width reduction part a1 to have a length of 80±5 mm, thereby achieving uniformity in the distribution of pressing pressure in the lengthwise direction of the wiper blade assembly.

With respect to the elastic members having different curvatures depending on the lengths thereof described above, when the length of the elastic member is 14 to 17 inches, k value in this inch range can be defined as 0.0020 to 0.0028, and when the length of the elastic member is 18 to 20 inches, k value in this inch range can be defined as 0.0032 to 0.0038.

Furthermore, when the length of the elastic member is 21 to 22 inches, k value in this inch range can be defined as 0.0042 to 0.0046, and when the length of the elastic member is 24 to 28 inches, k value in this inch range can be defined as 0.0054 to 0.0072.

As described above, assuming that the elastic members have different curvatures depending on the lengths thereof, the present invention is characterized in that the first width reduction part has a length of 80±5 mm in all elastic members regardless of the lengths of the elastic members.

While the embodiments of the present inventive concept have been described with reference to the attached drawings, it will be understood by those of ordinary skill in the art that various changes in form may be made without departing from the technical idea or essential features of the present inventive concept. It is therefore desired that the embodiments described thus far be considered in all respects as illustrative and not restrictive.

What is claimed is:

1. A wiper blade assembly comprising:
an elastic member having a first elastic member region and a second elastic member region,
wherein the first elastic member region includes:
a first body part extending in a first direction from a center part of the elastic member;
a first end part provided at an end of the first body part; and
a first body part center point which is a center of a length of the first body part, and a region ranging from the center part to the first body part center point is a first width maintaining part, and a region ranging from the first end part to the first body part center point is a first width varying part.

2. The wiper blade assembly of claim 1, wherein the first width varying part includes a first width reduction part, and the first width reduction part starts a reduction of a width of the elastic member at a first width reduction start part and ends the reduction of the width of the elastic member at a first width reduction end part.

3. The wiper blade assembly of claim 2, wherein the first width reduction part has a length of 80±5 mm.

4. The wiper blade assembly of claim 2, wherein the first width varying part includes a first one side constant width part which is a region ranging from the first end part to the first width reduction end part, and a first other side constant width part which is a region ranging from the first body part center point to the first width reduction start part.

5. The wiper blade assembly of claim 2, wherein the first width varying part includes a first protrusion disposed in the first width reduction part, and a second protrusion disposed adjacent to the first protrusion.

6. The wiper blade assembly of claim 5, wherein the first protrusion is disposed in a center region of the first width reduction part, and the second protrusion is interposed between the first protrusion and the first width reduction end part, and spacing between the first protrusion and the second protrusion is maintained equal to or greater than the width of the elastic member in the first width maintaining part.

7. The wiper blade assembly of claim 1, wherein the second elastic member region includes: a second body part extending in a second direction from the center part of the elastic member; a second end part formed at an end of the second body part; and a second body part center point which is a center of a length of the second body part,
a region ranging from the center part to the second body part center point is a second width maintaining part, and a region ranging from the second end part to the second body part center point is a second width varying part,
the second width varying part includes a second width reduction part, and the second width reduction part starts a reduction of a width of the elastic member at a second width reduction start part and ends the reduction of the width of the elastic member at a second width reduction end part, and
the second width reduction part has a length of 80±5 mm.

8. The wiper blade assembly of claim 7, wherein the second width varying part includes a second one side constant width part which is a region ranging from the second end part to the second width reduction end part, and a second other side constant width part which is a region ranging from the second body part center point to the second width reduction start part,
the second width varying part includes a third protrusion disposed in the second width reduction part, and a fourth protrusion disposed adjacent to the third protrusion, and
the third protrusion is disposed in a center region of the second width reduction part, and the fourth protrusion is interposed between the third protrusion and the second width reduction end part, and spacing between the third protrusion and the fourth protrusion is maintained equal to or greater than the width of the elastic member in the second width maintaining part.

9. A wiper blade assembly comprising:
a windshield contact member;
an elastic member supporting the windshield contact member having a center and two end locations, each location having a width; the elastic member including a width varying part where the width is reduced from the width of the center of the elastic member or the width at an end of the elastic member; the width varying member when pressed against a windshield, provides a uniform pressure distribution from the center of the elastic member to its ends.
